(19) United States
(12) Patent Application Publication
(10) Pub. No.: US 2004/0154000 A1
(43) Pub. Date: Aug. 5, 2004

(54) System and method for semantic software analysis

(76) Inventors: Kasra Kasravi, W.Bloomfield, MI (US); Bhupendra N. Patel, Troy, MI (US)

Correspondence Address: KRAMER LEVIN NAFTALIS & FRANKEL LLP, INTELLECTUAL PROPERTY DEPARTMENT, 919 THIRD AVENUE, NEW YORK, NY, 10022, US

(21) Appl. No.: 10/357,329

(22) Filed: Feb. 3, 2003

(51) Int. Cl. G06F 9/44

(52) U.S. Cl. 717/130; 717/141

(57) ABSTRACT

A method and system are presented for the semantic analysis of software. The method includes semantically analyzing one or more software compositions to define an attribute list of such software via said taxonomy, and storing each attribute list in a database or case library. In preferred exemplary embodiments the method further comprises defining a taxonomy against whose categories the results of the semantic analysis are mapped. An exemplary system embodiment of the invention includes a taxonomy, defined linguistic rules, and a semantic analyzer, where the semantic analyzer uses the linguistic rules to parse information from software.

### TECHNICAL FIELD

The present invention relates to the application of artificial intelligence techniques to software development. More particularly, the present invention relates to a system and method for the semantic analysis of software, such that it can be classified, organized, and archived for easy access and re-use.

### BACKGROUND INFORMATION

Software development plays a significant role in the global economy. Large companies in the business of, for example, providing enterprise computing services and solutions generally have software application development programs that are highly valuable, often involving the expenditure of several billion dollars annually. Notwithstanding the significant resources devoted to it, certain problems continue to plague software development. Such problems are well known, and include, for example, cost overruns, delays, bugs and errors, and maintenance, to name a few.

Many attempts have been made to address the problems associated with software development, and thus improve the software development process and it efficiency, such as, for example, the System Life Cycle initiative of Electronic Data Systems (“EDS”), of Plano Tex., as well as the Software Engineering Institute—Capability Maturity Model (SEI-CMM) undertaken at the industry level. One problem that has not been fully addressed, however, is redundancy.

A better understanding of existing software can aid in the development of future software. In fact, a large amount of existing software can be used as analogues or models for solving a related or similar problem in new software. Moreover, many lines of existing code can be used as-is, or with minor additions, as part of new software applications. Traditionally, software developers spend much of their time documenting their code and systems. These documents, as well as the code itself, can often provide much insight into the purpose, design, and characteristics of the software. However, manually reading existing software and associated documentation is often prohibitively time consuming and therefore not attempted on a large scale.

Thus, although software development entities could utilize the vast resources hidden in already written code maintained in their organization, they can rarely find it. While such code is found in current or past applications, or residing on one or more files on a given software developer's or computer engineer's computer within the organization, the conventional method currently used to exploit these hidden resources is extremely low-tech: word-of-mouth.

For example, assume that a software developer and/or computer engineer has an application which she is working on. She desires to write some code to implement a given functionality within that application. She is generally aware that, although some of the inputs and outputs may be different, the general functionality she desires to implement is very similar, if not identical to, functionalities that have been implemented in similar code by her present and former colleagues. Such old code may be, for example, in a different coding language but doing the same thing, or the old code may assume a 16 bit FAT as opposed to the desired 32 bit FAT, or be a computer diagnostic tool for reading and processing digital radiological images which is specific to an older modality as opposed to a desired newer one. In each of these examples, simply adapting pre-existing old code could supply the current software coding requirement.

Nonetheless, in the example discussed above, since there is neither a central search mechanism nor a central archive in which all software within her organization is automatically categorized and archived for easy retrieval, the software developer probably either (a) queries her current colleagues “Do you have any code that would do XYZ? or (b) sends an email querying her department or the overall company seeking the same information. If one of her colleagues happens to recall similar code, he or she may so inform our developer by word of mouth or email.

Generally, however, there is simply no intelligence that bridges the gap between someone who needs the code at a given moment and someone who happens to have the code sitting on their hard drive. Few, if any, of her colleagues will take the time to thoroughly search even their own files, let alone undertake a departmental or company-wide search. Thus, left with few remaining choices—she simply takes the path of least resistance and re-invents the wheel.

While there are a few websites which maintain modest software libraries, the contents of these libraries tends to be very limited, and the software is only accessible by browsing. Such websites simply do not contain enough code to be generally useful, and offer no intelligence to a user trying to locate a particular kind of software to accomplish certain defined functionalities. It is simply inefficient to browse through code online trying to find a particular function in a codestack.

The notion of “software reuse” has been discussed for many years, in connection with software components, class libraries or objects. However, despite all such efforts, a comprehensive technical solution does not exist to assist with the efficient reuse of software. As a result, many existing software components are unnecessarily re-developed and re-tested, resulting in wasted time and money as well as risking quality problems. This is because, for example, if new software is written in an independent development, it may contain errors and bugs which a re-testing process may not catch, or which do not emerge until the new software has been used for some time.

What is needed in the art is a system and method which facilitates the large scale mining of information from pre-existing software.

### SUMMARY OF THE INVENTION

A method and system are presented for semantic analysis of software. The method includes semantically analyzing one or more software compositions (e.g., software programs and any associated file information, comments and textual descriptions) to define an attribute list of such software compositions via a taxonomy, and storing each attribute list in a database or case library. In preferred exemplary embodiments, the method further comprises defining a taxonomy against whose categories the results of the semantic analysis are mapped. An exemplary system embodiment of the present invention includes a taxonomy, defined linguistic rules, and a semantic analyzer, where the semantic analyzer uses the linguistic rules to parse information from software and associated documentation to automatically create profiles (e.g., attribute lists) of existing software.

### BRIEF DESCRIPTION OF THE DRAWINGS

FIG. 1 illustrates an exemplary software taxonomy according to an embodiment of the present invention;

FIG. 2 illustrates an exemplary method for the semantic analysis of software according to an embodiment of the present invention; and

FIG. 3 depicts an exemplary modular software program implementing an embodiment of the method of the present invention.

### DETAILED DESCRIPTION OF THE DRAWINGS

The present invention facilitates classification, organization and archiving of existing software. In so doing, a system and method are presented for mining information from existing software and, if available, associated documentation, so as to automatically create a profile or attribute list for a given program or portion of a program embodied in such code.

In an exemplary embodiment of the present invention, software code and any associated file information and documentation is accessed, automatically read line by line, and subjected to a semantic analysis to determine its form and function and categorize it according to a classification system. The output of such semantic analysis is a software profile. A set of such software profiles can be stored in a database. A software developer (or other user) can then create, using the same data structure as found in the set of software profiles, a new profile which describes the attributes of a desired software program. By searching against the database of existing software profiles, the system can find profiles most similar to the new profile and provide the developer with existing software that may be suitable for use in the new program. The existing software, representing the closest examples in the database to the desired software, makes the user's programming task easier, if not moot.

Content Based Searching

One functionality contemplated by exemplary embodiments of the present invention is facilitating software retrieval using content based searching. In such searching, what is searched is not each line of code or text with a real time “content searcher” algorithm every time a developer desires to find useful existing code, but rather a profile of each software component which can be created once and stored by the system. Such profiles can “encode” certain key information about a software program. Searching against a collection of such profiles is much less computationally intensive, as well as much more efficient, than searching the actual software and associated documentation in real time.

Thus, suppose an organization desires to make use of its collective output of software. The first step is cataloguing and indexing the software. A large amount of software already in existence at the organization would present a very time consuming and expensive task if human software analysts were engaged to read, analyze and create a profile for all of the software in the organization's products and files. To improve the efficiency and cost of such a process, the present invention contemplates automatically analyzing the extant software and creating a searchable set of software profiles.

While the output of the present invention is contemplated to be used in a searchable database, the present invention primarily addresses the “encoding” side of such a system, e.g., the creation of profiles for existing software. The “decoding” side, e.g., searching a software profile library and identifying relevant existing code, is described in a copending patent application filed concurrently, having the same applicants, and being under common assignment herewith, entitled “SYSTEM AND METHOD FOR SOFTWARE REUSE,” the disclosure of which is hereby fully incorporated herein by reference.

Textual Data Mining

Recent advances in textual analysis have provided sophisticated tools and algorithms for data mining of textual data. Inasmuch as software is a form of textual data, it can therefore be mined for the information buried within it. Specialized linguistic rules can be developed to extract specific as well as general information from software, such as its language, arguments, author, design purpose, key constructs, modules called, return values and types, etc.

For ease of illustration herein, the term “software” is understood to include file names, actual software code, inline comments, as well as any supplemental and/or additional documentation. An individual “piece” of software, such as a program or a portion thereof (including, as above, file names, actual software code, inline comments, as well as any supplemental and/or additional documentation), will be referred to herein as a software “composition.” In exemplary embodiments, linguistic rules can be based on a software “taxonomy” and thus used to search for corresponding software attributes. As is known in the art, a taxonomy is a system of classification that facilitates a conceptual analysis or characterization of objects. A software taxonomy thus allows for the characterization of software.

Software Taxonomy—A Set of Descriptive Categories

Thus, as a first step in automatically analyzing existing software, a software taxonomy should be developed. A taxonomy provides a set of criteria by which software programs can be compared with each other. Using a taxonomy, software can be assigned a value for each category in the taxonomy that is applicable to it, as described more fully below. For ease of illustration herein, a taxonomy is spoken of as containing “categories.” When these categories are presented in a software profile, they are generally referred to as “fields,” where each field has an associated “value.” For example “Type” and “Programming Language” could be exemplary taxonomical categories, and their respective values in a software profile could be, for example, “Scientific” and “Fortran.”

In preferred exemplary embodiments a software taxonomy can be flexible, allowing its categories to be changed or renamed over time. Software profiles created using a flexible taxonomy may thus have non-identical but semantically similar fields, and thus search rules for comparing two software profiles whose fields are different but similar would need to be implemented. Profiles created using a flexible taxonomy are said to be “non-rigid.” Rigid profiles assume that only an element by element comparison is valid. Thus, rigid profiles are considered as dissimilar unless each and every field for which one has a value is valued in the other. Non-rigid, or flexible, software profiles can be compared, and a mutual similarity score calculated, based upon semantic equivalence between fields with different names, as described below.

In exemplary embodiments of the invention, a taxonomy such as that provided in Table A below could be utilized.

TABLE A
Exemplary Software Taxonomy

| Industry | Complexity | Operating System |
|---|---|---|
| Financial | Scientific | Windows |
| Medical | Business | Linux |
| Engineering | Conversion | MVS |
| Scientific | Financial | Unix |
| Low-Level Function | Language | Tool Type |
| Date | C/C++ | Add-in |
| Time | Java | Applet |
| Financial | VB | Application |
| Statistical | Cobol | ASP |
| Textual | Fortran | JSP |
| Arithmetic | Smalltalk | Servlet |
| Logical | | Wizard |
| High-Level Function | General Attributes | Component Type |
| DBMS | Date | MFC |
| CAD | Version | J2EE |
| Imaging | Ownership | Corba |
| Printing | Cost | EJB |
| Localization | Type | ActiveX |
| SQL | Freeware | COM |
| Device Driver | Shareware | DCOM |
| Testing | Internal | Applet |
| ECommerce | Purchase | NET |
| Wireless | Digital Signature | VCL |
| Mobile | Size | DLL |
| XML | Authoring Language | Servlet |
| Integration Tool | English | CLX |
| Search | Russian | VBX |
| | German | JavaBeans |
| | French | |
| Application Server | Container | Arguments |
| WebLogic | IBM VisualAge | Quantity |
| JavaWebServer | MS Office | Data Type |
| IBM WebSphere | MS SQL Server | |
| Bluestone | Netscape | |
| | Oracle Jdeveloper | |

Return Value
Boolean
Textual
Numerical
Date
Time

The exemplary taxonomy presented in Table A illustrates software taxonomies. In general, a given exemplary embodiment will utilize one or more taxonomies that allow software to be characterized. This is because taxonomies are often domain specific, and one set of categories that accurately describes one type of software, e.g., embedded systems for controlling household appliances, may have little applicability to another type, such as, e.g., a web browser.

While an exemplary highly detailed taxonomy can be used that defines a software composition absolutely uniquely, it is often not necessary to use so much detail in a taxonomy that each software program is described in an exhaustive and absolutely unique way. Thus, it may be sufficient to describe software by general form and function, such that the semantic analysis of two or more software programs may, for example, output a similar or identical software profile. A software taxonomy should be detailed enough to allow someone searching against a set of software profiles to locate a manageable number of similar software programs.

As can be seen with reference to Table A, there are 13 major headings in an exemplary taxonomy, each of which is further divided into two or more subcategories. Therefore, a given software composition can be categorized using the criteria of this exemplary taxonomy, as shall be described below.

In some cases sub-categories are further divided into sub-subcategories. This three-tiered hierarchical structure can be seen, for example, with reference to the top level category “General Attributes,” appearing in the third row and second column of Table A. Under the “General Attributes” top level category there appear eight subcategories, comprising “Date,”“Version,” “Ownership,” “Cost,” “Type,” “Digital Signature,” “Size,” and “Authoring Language.” Within each of the subcategories “Type” and “Authoring Language,” there are four sub-subcategories, respectively.

In Table A, the “Type” subcategory of the “General Attributes” top level category is further divided into sub-subcategories of “Freeware,” “Shareware,” “Internal,” and “Purchase.” The “Authoring Language” subcategory of the “General Attributes” top level category also has four sub-subcategories, namely “English,” “Russian,” “German,” and “French.”

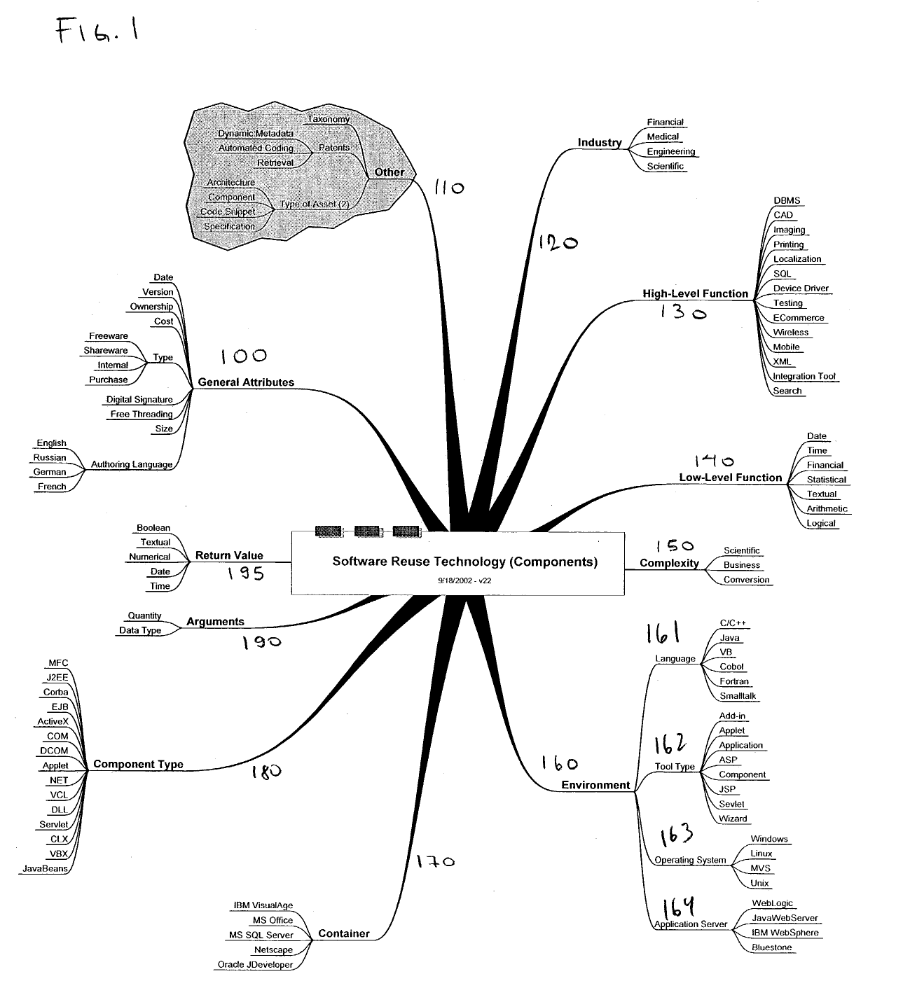

To illustrate some of the design choices in constructing taxonomies, an alternative exemplary software taxonomy is depicted in FIG. 1. This taxonomy has somewhat more detail than that of Table A. With reference to FIG. 1, eleven top level categories are shown, including General Attributes 100, Other 110, Industry 120, High-Level Function 130, Low-Level Function 140, Complexity 150, Environment 160, Container 170, Component Type 180, Arguments 190 and Return Value 195. Contrasted with the exemplary taxonomy of Table A, it is noted that the top level categories of Language, Tool Type, Operating System and Application Server, which were high-level categories in the exemplary taxonomy of Table A, are now subcategories of a new top-level category Environment 160 in the exemplary taxonomy of FIG. 1. Additionally, a new top-level category, Other 110 has been added, itself divided into numerous subcategories and sub-subcategories.

As noted above, since software can have domain specific attributes, domain specific taxonomies can be used. However, even within a specific software domain, numerous design choices are available. For example, the exemplary taxonomies of FIG. 1 and Table A reflect a tradeoff between level of detail and computing resources required to create software profiles using the taxonomy. The more detailed a taxonomy is, the more profile fields that are needed to be populated using a semantic analysis. Thus, where the number of software components is small to moderate, a lower resolution may be sufficient, and a slightly less detailed and less complex taxonomy can be used, such as, for example, that of Table A. Alternatively, where there are a large number of software components to classify and mutually distinguish, a larger resolution may be desired, and a more detailed taxonomy, such as for example that depicted in FIG. 1, may be used.

An Exemplary Software Composition

Table B contains an exemplary software program that can be analyzed according to a method of the present invention. Because the example program of Table B is a simple one, its semantic analysis will be illustrated using the exemplary taxonomy presented in Table A (the less detailed taxonomy). The exemplary program consists of a simple C program which has one section, which defines no functions and which simply adds a sequence of integers from one to “LAST”, where LAST is a global variable representing the final number in the sequence. Thus, if LAST is defined as 10, the program will calculate and print out the sum of the numbers from 1 through 10 inclusive and then return a value of zero. The program has, besides the C code, a header comment and in-line comments which explain the program and what it does.

As is known in the art, real world software programs are generally considerably more lengthy and complex than the exemplary software program of Table B. However, for purposes of illustration herein, the exemplary software program presented in Table B (hereinafter sometimes referred to as “add.c”) will be utilized to illustrate semantic analysis of a software program according to a method of the present invention.

TABLE B
Exemplary Software Program

/* add.c
* a simple C program
*that adds a sequence of numbers
*from 1 to LAST and prints the sum. LAST is a globally definable
*final number in the sequence.
*
*Version 1.3
*December 3, 2002
*Programmer: Sheila Stone
*Ownership: Educational Programming, Inc.*/
#include <stdio.h>
#define LAST 10
int main( )
{
int i, sum = 0;
for ( i = 1; i <= LAST; i++ ) {
sum += i;
} /*for loop to run through integers from 1 to LAST inclusive*/
printf(“sum = %d\n”, sum);
return 0; /*value that main returns*/
}

Add.c can be categorized using the exemplary taxonomy of Table A. It is noted that an automatic system contemplated by embodiments of the present invention would read every line of an exemplary program including both code and comments. It would also read any purely descriptive documentation provided with the program. There are various ways that such a system could access and read such software. In exemplary embodiments there could be, for example, a scraper program that automatically extracts all software code and documentation from all computers in an organization. Alternatively, in other exemplary embodiments, developers could manually save all their source code and descriptive documentation in a central directory. The system could go to such a directory, access all files stored thereon and subject them to a semantic software analysis.

Linguistic Analysis: Syntactic and Semantic Analyses

Add.c may, for example, be linguistically analyzed according to known techniques. Linguistic analysis, as used herein, comprises two stages. Syntactic (or syntax) analysis and semantic analysis. Syntax analysis, as is known in the art, involves recognizing the tokens (e.g., words and numbers) in a text through the detection and use of characters such as spaces, commas, tabs etc. Thus, for example, first, after a syntactical analysis of a software composition, a system according to the present invention would have acquired a sequential list of the tokens present in the software. Second, for example, syntax analysis would then be implemented to inspect the tokens and compare them against known rules to recognize (a) the programming language used (e.g., C++, Visual Basic, Java) and (b) the key constructs (e.g., comments, functions, and/or classes) comprising the code and any associated documentation.

Third, for example, given the basic constructs recognized as described above, semantic analysis rules could be applied to further analyze the software. Such semantic analysis rules, for example, look for keywords as well as concepts and relations, such as, for example, author's names, the industry for which the software was written, major function(s) of the software, and other categories as are listed in a software taxonomy.

Fourth, for example, the results of the three processes described above are used to create a software profile. When the processes above described are applied to a plurality of software, a library of software profiles can be created. Such profiles could be in a variety of formats as are known in the art, such as, for example, cases for use in a case library of a case based-reasoning system, semantic vectors, etc. The fields of the software profiles would be defined, as above, by an exemplary software taxonomy. When, for example, the software profiles are in a format that can be interpreted and processed by a data processing device, large scale automatic searching of the software profiles of an entire company can be accomplished.

Thus, in exemplary embodiments, a software dictionary as well as syntactic rules, can be initially used to parse information from software and its accompanying documentation. Subsequently, linguistic rules could be applied that consider much more than simply the key words and syntax themselves by performing shallow or deep parsing of the text and code, and considering the relationships among the software constructs and their positional factors. In addition, terms appearing in the software could be looked up in a thesaurus for potential synonyms, and even antonyms or other linguistic conditions can be considered as well.

Such linguistic rules essentially perform a semantic analysis of the software. The outcome of such a semantic analysis of software could be presented in multiple forms, including (a) the development of software in class libraries, or (b) summaries of software assets. The outputs of a semantic analysis could also be used for supporting training and communications, or even for generating system documentation. Using the results of a semantic analysis, similar programs and systems can be identified for consolidations.

Exemplary Software Profile Population

Using the exemplary taxonomy of Table A as applied to the software program of Table B, a partial population of a software profile will be next described. Such population involves automatically assigning values to the various fields of the software profile. Referring to the exemplary taxonomy of Table A, the “Language” field would have a value “C/C++.” This is because a linguistic analysis of the “add.c” program of Table B would learn that the program was written in C. This information is available in the file extension of the program, i.e., “______.c”, and can also be gleaned, using known rules for programming language recognition, from the first line of the header as well as from the C programming language tokens and symbols contained in the program itself. A “General Attributes/Date” field would be filled in with “Dec. 3, 2002” and a “Version” field with “1.3.”

A “Low Level Function” field could have an “arithmetic” value. The programming language of add.c is obviously C, therefore the sub-category “C/C++” would be chosen as the value of a “Language” field. For a “Tool Type” field add.c's profile would be valued with “Application,” or perhaps “Add-in.” The value for “High Level Function” would need to be determined by more information than is provided in Table B, but theoretically any number of the subcategories provided under High Level Function in Table A could be chosen. An “Ownership” field would be valued with “Educational Programming, Inc.” “Type” could be valued as “Internal,” and there would be no “Digital Signature” value. “Size” could state the size in bytes of the program, and “Authoring Language” would have “English.” The categorization could be completed in similar fashion.

It is noted that in the exemplary taxonomy of Table A most low level subcategories (e.g., “C/C++” or “Java”) or sub-subcategories (e.g., “English” or “Shareware”) are specific enough to serve as values of fields in a software profile which are defined by their respective subsuming category (e.g., “Language”) or subcategory (e.g., “Authoring Language” or “Type”). A few low level subcategories (e.g., “Date” or “Version”) are more general and thus take a specific value (e.g., “Dec. 3, 2002” or “1.3”) which must be obtained from the linguistic analysis of a given software composition, and which is not available from the taxonomy itself.

As noted above, real world software generally has considerably more detail than add.c. Thus, a real world software profile would have values for a substantial portion of the available fields provided by a given taxonomy.

Software Profile Format

I. Semantic Vectors

As noted, there are various ways of expressing a software profile according to an embodiment of the present invention. The format chosen can be a function of how the software profiles are to be used. In exemplary embodiments software profiles can be used for automatic searching, as noted above. Thus, in exemplary embodiments, a software profile can be considered as a semantic vector. The components of the vector can be, for example, fields from the taxonomy. Thus, an exemplary taxonomy with N general categories and subcategories could map to a N×1 semantic vector. Every component of the vector (i.e., field of the software profile) could have a value obtained form the linguistic analysis of software as described above.

Thus, add.c could have a software profile, for example, expressed as a semantic vector with twenty components corresponding to the twenty general categories and subcategories of the example taxonomy of Table A, comprising {Industry, Complexity, Operating System, Low-Level Function, Language, Tool Type, High-Level Function, Date, Version, Ownership, Cost, Type, Digital Signature, Size, Authoring Language, Component Type, Application Server, Container, Arguments, and Return Value}.

II. CBR Cases

As another example, a linguistic analysis using an exemplary taxonomy (one not identical to that of Table A) could be applied to add.c resulting in an exemplary output expressed using the format (Category=Value), as follows:

Filename=add.c

Programming Language=C

Author=Sheila Stone

Date=Dec. 3, 2002

Company=Educational Programming, Inc.

Construct=function

Construct Name=main

Complexity=Arithmetic

Arguments=None

Return Value Type=None

According to an exemplary embodiment of the present invention, the output of such an exemplary linguistic analysis can be used to create a software profile for add.c in the form of a “case,” to be stored in a “case library.” As is known in the art, case libraries are used in connection with “case-based reasoning” systems. Case-based reasoning (“CBR”) systems are artificial intelligence systems seeking to emulate human experiential recall in problem solving. They utilize libraries of known “cases” where each such case comprises a “problem description” and a “solution.” Case based reasoning is one manner of implementing expert systems.

For example, an expert system can be built to store the accumulated knowledge of a team of plastic surgeons. Each case could comprise a real world problem that a team member had experienced as well as the solution she implemented. A system user, such as, for example, a young resident in plastic surgery faced with a plastic surgery problem, could query the case library to find a case reciting a similar problem to the one currently faced, much like how a human when trying to solve a given problem is reminded of a similar situation he once dealt with and the actions he took at that time. The case's solution could be relevant and useful to the young resident's current situation, thus passing on the “accumulated experience” embedded in the CBR system to her. To query the case library a user must formulate her “input problem” in a format that can be readily searched against the problem descriptions contained in the case library. Thus, a problem formulation needs to map the input problem to certain categories, preferably the same categories (supplied by a common taxonomy) used in mapping the real world problems to their “problem descriptions” in the case library.

In a similar manner, CBR can be used to search software profiles created according to an exemplary embodiment of the present invention. To do this, software profiles created by a semantic analysis of software need to be formatted as cases. In an exemplary CBR system, a software profile would correspond to the “problem description” and the software itself to the “solution” of a case. Case creation can be achieved by populating appropriate fields with the values extracted from semantic analysis of a software composition according to the present invention, as illustrated above. Cases have fields corresponding to a taxonomy. Such a taxonomy can be similar to, but in robust systems need not be identical to, a taxonomy used in the linguistic analysis of the software, as described below. This allows for interoperability of the respective CBR and semantic software analysis systems while ongoing development and flux in their respective taxonomies occurs. Thus, a partial case for add.c may, for example, resemble the following case excerpt presented in Table C:

TABLE C
Exemplary Partial Case Excerpt

| | Programming | | | Operating | | | Component |
|---|---|---|---|---|---|---|---|
| File Name | Language | Author | Date | System | Arguments | Complexity | Type |
| | C | Sheila Stone | Dec. 12, 2002 | | None | Arithmetic | |

In this example the File Name, Operating System, and Component Type fields of the CBR case were not populated, because the taxonomy used for the exemplary semantic analysis (whose categories appear in the exemplary output, provided above) and that used in the creation of the exemplary case library were not identical. Upon application of synonyms, as described above, “File name” for example, could be mapped to “Filename,” and “Component Type” mapped to “Construct.” An Operating System value was not extracted from the software, and therefore remains unpopulated in the case. Parameters such as “Construct Name” do not map to the exemplary taxonomy used to populate the case library (such as that depicted in FIG. 1), and therefore may be ignored, or stored elsewhere for future use. Thus, after all processing, the software profile case could be, for example, that presented in Table D:

TABLE D
Exemplary Case Excerpt

| | Programming | | | Operating | | | Component |
|---|---|---|---|---|---|---|---|
| File Name | Language | Author | Date | System | Arguments | Complexity | Type |
| add.c | C | Sheila Stone | Mar. 12, 2002 | | None | Arithmetic | function |

To be robust, semantic analysis based upon a given taxonomy must have some capability for handling synonyms. For example, a given taxonomy may be used to encode a self described arithmetic program into a software profile, where the taxonomy being used to classify the program does not have an “arithmetic” field, but rather only a “mathematical” field. In analyzing such an example program synonyms for taxonomy categories and subcategories (and thus for software profile fields and values) can also be considered and the “arithmetic” of the program interpreted as the “mathematical” of the taxonomy and software profile. For example, a “Low-Level Function “field of an exemplary software profile based upon such a taxonomy would be valued as “Mathematical” even though the program only uses the word “Arithmetic.” Alternatively, if neither the word “arithmetic” nor any direct synonym for it appears in a software composition, the semantic analysis would need to associate words which do appear in the program and which indicate an “arithmetic” quality, such as, for example, “adds,” “numbers,” “integers,” and “sum,” with an arithmetical function, and return a value of “Arithmetic” for a “Low Level Function” field.

As can be seen therefore, it is not enough to simply develop a taxonomy; rather, an exemplary system according to an embodiment of the present invention must also have a set of rules by which it is determined how the taxonomy is used to encode—e.g., semantically analyze and produce a software profile for—the content and attributes of each software component desired to be analyzed.

From the above discussion it can be seen that there are a number of issues relating to how a particular taxonomy is constructed, as well as to how an exemplary software program is analyzed in light of such taxonomy. Such processing depends upon defining certain linguistic rules, including, for example, syntactic rules and semantic rules, as described below, as are generally known in the art in the fields of artificial intelligence, data mining, and semantic analysis.

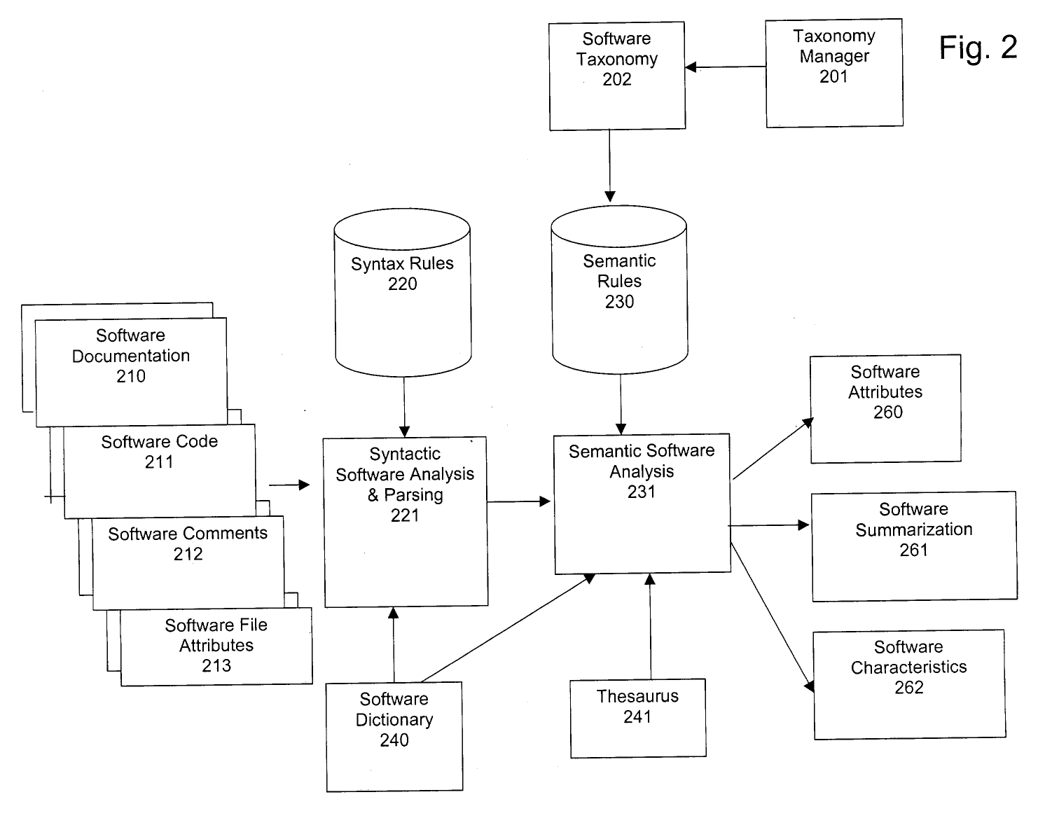

An exemplary process of the present invention is depicted in FIG. 2. The process depicted in FIG. 2 can be implemented in either hardware, software, or any desired combination of the two. The process depicted in FIG. 2 is a logical one and, in any given software and/or hardware implementation, one or more of the depicted modules could be combined with one or more other modules.

With reference to FIG. 2, the inputs to the depicted software analysis system are software documentation 210, the software code itself 211, the embedded comments in the software code 212, such as those seen in the exemplary program of Table B, and software file attributes 213. Such file attributes could include, for example, File Extensions, File Structure, Path, Archived, Not-archived, Size (in Kb), Operating System, Creation Date, Last Modification Date, Server, etc.

Continuing with reference to FIG. 2, it can be seen that a taxonomy manager 201 provides a given software taxonomy 202, which will be used in analyzing the software. The taxonomy manager 201 allows, via an interface as known in the art, a system administrator or user to manually change or modify the taxonomy, such as, for example, when experience with a given system grows. Additionally, a taxonomy manager may be automated, using, for example, some type of genetic algorithm in conjunction with a scoring algorithm, causing the taxonomy to be automatically refined in response to user feedback from retrieval searches. Thus, in such exemplary embodiments, an exemplary system such as is depicted in FIG. 2 can become more efficient with use, inasmuch as the taxonomy used in semantic analysis can achieve a more and more optimal division of the “semantic plane” into various categories and subcategories, adding detail where necessary and discarding redundant categories or subcategories.

Since, as noted above, optimal taxonomies can be domain specific, a taxonomy manager 201 can store a plurality of taxonomies 202, each adapted to the analysis of a particular type of software. Such types could include, for example, business/economic, engineering/scientific, etc.

Continuing with reference to FIG. 2, a software dictionary 240 and syntax rules 220 are used to process the input software 210-213 by initially performing syntactic software analysis and parsing 221. The results of such processing at 221 are fed to the semantic software analysis module 231, which, using semantic rules 230 and a software taxonomy 202, performs shallow or deep parsing of the text and code, considering the relationships among the software constructs, as well as their positional factors. The semantic software analysis module 231 may in its processing access a thesaurus to look up synonyms, or even consider antonyms as well as other linguistic conditions.

With reference to FIG. 2, and the exemplary program of Table B, the following are exemplary outputs from an exemplary application of Syntax Rules 220 and Semantic Rules 230 to line 15 of the code, where the words “int main( )” appear:

Output of Syntactic Analysis 220:

1—Space detected in position 4

2—End of sentence detected in position 11

3—First token is “int” at position 1

4—Second token is “main( )” in position 5

5—“int” as the first token in a sentence implies a an integer return value

6—“main( )” implies a function with no argument

Output of Semantic Analysis 231, Assuming a Complete Syntactic Analysis 221 as Exemplified Above:

1—The programming language is C (e.g., with reference to the comment in the second line)

2—The construct is a function (e.g., with reference to the presence of “int main( )”)

3—The industry is Education (e.g., with reference to the comment in line 10)

As can be seen from these examples, a syntactic analysis is more literal, searching for characteristic markers such as spaces and end of sentences, as well as certain tokens. Syntactic analysis can detect these objects, but cannot discern much meaning from the totality of objects found. Semantic analysis takes as inputs all of the objects located by the syntactic analysis and applies semantic rules to discern meaning.

Again with reference to FIG. 2, modules 221 and 231 are the functions that apply the syntax rules 220 and semantic rules 230, respectively, to the software composition under semantic analysis. These functions implement such rules, apply them to the software being analyzed, generate the output, and store the output (in, for example, database or memory) for subsequent use by other modules.

The output of the exemplary semantic software analysis depicted in FIG. 2 is threefold. This output comprises, for example, Software Attributes 260, Software Summarization 261 and Software Characteristics 262. The various outputs 260, 261 and 262 need not all be desired in exemplary embodiments. They represent possible outputs that an exemplary system can produce. They differ with respect to the format the output data is presented in, but not in its the content. In exemplary embodiments, one or more of such possible outputs may be desired. For example, Software Attributes 260 are software profiles, generally presented in tabular form, that can be used to populate a software retrieval library, and can, in exemplary embodiments, be similar to the exemplary case excerpt of Table D, above. Such output lists, for example, a number of fields (e.g., the categories from the taxonomy) and the corresponding values for each field that a particular software component was found to have.

Alternatively, output formatted as Software Summarization 261 or Software Characteristics 262 is generally not used to populate searchable libraries of software profiles. Rather, these latter output types are generally used by humans. Software Summarization 261 represents a narrative summary of the tabular information presented by a Software Attributes 260 exemplary table, such as, for example, the case of Table D. Such a narrative is preferably in well written complete sentences, and describes, for example, the various categories and their values in human readable form. In exemplary preferred embodiments, such narrative can be automatically generated using known artificial intelligence techniques.

Software Characteristics 262 represents yet another exemplary output format, typologically falling somewhere in between that of the other two formats discussed above. As with Software Summarization 261, its intended use is not the population of software profile libraries. Also, it does not require a narrative in full sentences or compliance with the formalities that are used in a typical Software Summarization 261 output. This is because the intended use of a Software Characteristics 262 output is more in the nature of internal reporting, and is less formal. Software Characteristics 262 is an output format used, for example, to report the software production of a given department or project team during a certain business period to, for example, a manager or other reviewer. Such output can be used, for example, to collectively describe a number of software components for purposes of various analyses, such as, for example, the true cost of a software development program.

The system and methods of the present invention offer numerous benefits to those entities in the business of software development for internal and external use. The system and methods of the present invention offer a reduction in the software development cycle. This, in turn, results in significant savings of time, quality, and costs. Specific benefits are, for example, (a) effective management of software assets at a large scale; (b) support for large-scale software reuse; (c) reduction in application development costs and time; (d) better positioning of software development companies in highly developed industrial economies for competition with offshore software development concerns; (e) reduction in software documentation; and (f) industry-level/international though leadership in software development.

Not only could a software development enterprise use the methods and system of the present invention to support the large-scale deployment of software re-use within its own enterprise, but an exemplary system, such as that contemplated by the present invention, could be commercialized. Such a system would offer the capability as a web service to clients involved with software development.

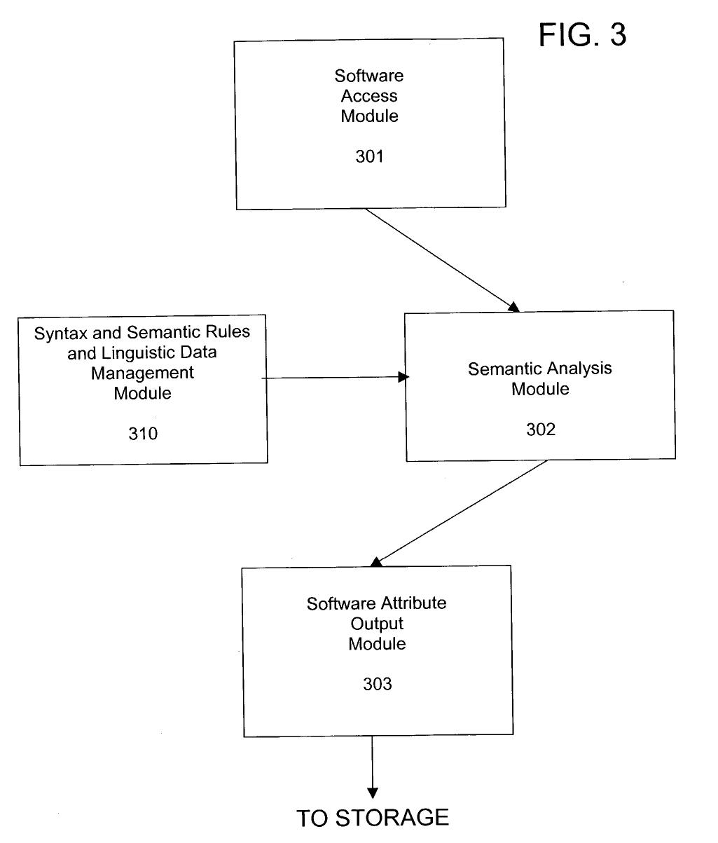

FIG. 3 depicts an exemplary modular software program of instructions which may be executed by an appropriate data processor as is known in the art, to implement an exemplary embodiment of the present invention. The exemplary software may be stored, for example, on a hard drive, flash memory, memory stick, optical storage medium, or such other data storage device or devices as are known in the art. When the software is accessed by the CPU of an appropriate data processor and run, it performs, according to an exemplary embodiment of the present invention, a method of semantic software analysis. The exemplary software program has, for example, four modules, corresponding to four functionalities associated with an exemplary embodiment of the present invention.

The first module is, for example, a Software Access Module 301, which can access a software composition for analysis. A second module is, for example, a Semantic Analysis Module 302, which, using a high level computer language software implementation of the functionalities described above, performs a semantic analysis of the software. Module 302 accesses syntax rules and semantic rules, as well as linguistic data such as, for example, thesauri and dictionaries, from a third module, for example, a Syntax and Semantic Rules and Linguistic Data Management Module 310.

Finally, the Semantic Analysis Module 302 outputs the results of its analysis to a fourth module, for example, a Software Attribute Output Module 303, which may format the semantic analysis results in one or more formats or data structures, for storage in, for example, a database or case library.

Modifications and substitutions by one of ordinary skill in the art are considered to be within the scope of the present invention, which is not to be limited except by the following claims.

What is claimed:

1. A method of semantic software analysis, comprising:
inputting software;
performing a semantic analysis on the software; and
outputting a profile of the software.

2. The method of claim 1, wherein said software includes at least one of file names, actual software code, inline comments, and supplemental and/or additional documentation.

3. The method of claim 1, wherein said semantic analysis includes determining values of the software for predetermined categories.

4. The method of claim 1, wherein said semantic analysis includes applying linguistic rules to the software.

5. The method of claim 4, wherein said applying linguistic rules comprises first applying syntax rules and subsequently applying semantic rules.

6. The method of claim 3, further comprising defining a taxonomy, wherein said defined categories are based upon said taxonomy.

7. The method of claim 1, wherein said output profile is formatted according to user determined formats, including at least one of an attribute table, a software summary, and a software characteristics report.

8. A method of creating an attribute list for software, comprising:
defining a taxonomy;
semantically analyzing software to define an attribute list of said software via said taxonomy; and
storing each attribute list.

9. The method of claim 8, wherein said software includes at least one of file names, actual software code, inline comments, and any supplemental and/or additional documentation.

10. The method of claim 8, wherein the semantic analysis comprises application of linguistic rules to the software.

11. The method of claim 10, wherein said linguistic rules comprise syntax rules and semantic rules.

12. A method of populating a searchable software profile library, comprising:
accessing two or more software compositions;
performing a semantic analysis on each software composition;
outputting a profile of each software composition; and
storing the profiles in a library.

13. The method of claim 12, wherein said semantic analysis includes determining values that each software composition has for certain categories listed in a taxonomy.

14. The method of claim 12, wherein said semantic analysis includes applying linguistic rules to the software composition.

15. The method of claim 14, wherein said applying linguistic rules comprises first applying syntax rules and subsequently applying semantic rules to each software composition.

16. The method of claim 12, wherein the taxonomy may vary as applied to various software compositions.

17. A system for semantically analyzing software, comprising:
a taxonomy;
defined linguistic rules; and
a semantic analyzer which can access the taxonomy and the defined linguistic rules, wherein the semantic analyzer uses the linguistic rules to parse information from software.

18. The system of claim 17, further comprising a thesaurus accessible by the semantic analyzer, wherein said semantic analyzer consults the thesaurus for synonyms, antonyms or other linguistic conditions.

19. The system of claim 17, further comprising at least one additional taxonomies each corresponding to a particular type of software, which a user may select for use in a given semantic analysis.

20. The system of claim 17, further comprising a user interface, whereby a user can at least direct the system where to access software components, select one or more taxonomies to be used in semantic analyses, select an output format and select linguistic rules.

21. The system of claim 17, where said software includes at least one of file names, actual software code, inline comments, and any supplemental and/or additional documentation.

22. A computer program product comprising a computer usable medium having computer readable program code means embodied therein, the computer readable program code means in said computer program product comprising means for causing a computer to:
access a software composition;
perform a semantic analysis on the software composition; and
output a profile of the software composition.

23. A computer program product comprising a computer usable medium having computer readable program code means embodied therein, the computer readable program code means in said computer program product comprising means for causing a computer to:
access two or more software compositions;
perform a semantic analysis on each software composition;
output a profile of each software composition; and
store the profiles in a library.
